(19) United States
(12) Patent Application Publication
(10) Pub. No.: US 2007/0171473 A1
(43) Pub. Date: Jul. 26, 2007

(54) Information processing apparatus, Information processing method, and computer program product

(75) Inventor: Masajiro Iwasaki, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Ricoh Company, Ltd.

(21) Appl. No.: 11/698,645

(22) Filed: Jan. 26, 2007

(30) Foreign Application Priority Data
Jan. 26, 2006 (JP) 2006-017735

(51) Int. Cl. G06K 15/00

(52) U.S. Cl. 358/1.18; 358/1.13

(57) ABSTRACT

An information processing apparatus includes an input unit, an object extracting unit, and an integrating unit. The input unit receives input of object information about an object rendered in a unit and positional information of the object about its position within document data, from each page of the document data. The object extracting unit extracts objects included in an area of image, diagram or graph based on input positional-information of the objects. The integrated-image creating unit creates an integrated image of each area by integrating extracted objects.

### PRIORITY

The present application claims priority to and incorporates by reference the entire contents of Japanese priority document, 2006-017735, filed in Japan on Jan. 26, 2006.

### BACKGROUND OF THE INVENTION

1. Field of the Invention

The present invention relates to a technology for processing document information that includes objects.

2. Description of the Related Art

Recently, there has been an increase in the volume and the number of electronic documents due to improved computer related technologies and enhanced network environment. This has enhanced paperless workflow in offices.

People create various kinds of documents on personal computers (PCs) as electronic documents. They may then edit, copy, transmit, or share the created electronic documents with other PCs or on servers. The PC or the server in which such an electronic document is saved can be connected to another PCs via networks, so that a person can read and edit the electronic document from another PC.

Under such an office environment, a plurality of people create electronic documents with a plurality of PCs, consequently, and it is difficult to manage each document for common use. This may result in confusion between users. For example, because a user does not know in which PC and in what way a necessary electronic document is saved, the user cannot search the document. Therefore, several document management systems are currently proposed.

For example, Japanese Patent Application Laid-open No. H8-212331 discloses a technology to store a scanned document, a facsimile document, an electronic document created by an application program, a Web document, and the like, associated with original data, the text file, and thumbnails of every page, document by document. As a result, electronic documents can be managed collectively regardless of format differences.

Furthermore, recently, information stored as an electronic document can be attached with various types of data, such graphics data or image data, in addition to document data, due to improved computer related technologies.

However, according to the technology disclosed in the patent document No. H8-212331, an original file is associated with only texts and thumbnails of respective pages. In other words, if data other than text, such as an image, is attached to an electronic document, the attached data cannot be managed in association with the electronic document.

To manage document data with respect to each individual data described above, relevant data cannot be divided into appropriate units. It is difficult to divide a document data into areas appropriate for searching or referring by a user.

For example, when dividing document image data, it is easy to divide the document image data into objects in the minimally-size unit that forms the document image data. However, a single object has no meaning, so that the user cannot understand contents when referring the object. Moreover, it is difficult to search for objects each of which has no meaning by setting search conditions. This is quite obvious when an object is obtained by dividing a diagram into elements that form the diagram. Therefore, it is necessary to combine objects into an appropriate area, and to manage them area by area.

### SUMMARY OF THE INVENTION

An information processing apparatus, information processing method, and computer program product are described. In one embodiment, an information processing apparatus comprises an input unit that receives input of object information and positional information each object, the object information being information about each of the objects rendered in a certain unit that is included in a page of document information, and the positional information being information about position of each of the objects within the document information; an extracting unit that extracts objects included in an area in the document information based on the positional information; and an integrating unit that integrates extracted objects thereby creating an integrated image of the area.

### BRIEF DESCRIPTION OF THE DRAWINGS

FIG. 1 is a block diagram of a personal computer (PC) according to a first embodiment of the present invention;

FIG. 2 is a schematic illustrating a document management table present in a document meta database in the PC shown in FIG. 1;

FIG. 3 is a schematic illustrating a page management table present in the document meta database in the PC shown in FIG. 1;

FIG. 4 is a schematic illustrating an area management table present in the document meta database in the PC shown in FIG. 1;

FIG. 5 is a schematic illustrating an example of document data edited by an editing application program on the PC shown in FIG. 1;

FIG. 6 is a schematic illustrating data that the editing application program creates as drawing codes from the document data shown in FIG. 5;

FIG. 7 is a schematic illustrating a coupling process at which an object extracting unit of the PC shown in FIG. 1 couples character objects included in a same line;

FIG. 8 is a schematic illustrating a coupling process at which the object extracting unit shown couples character objects included in different lines;

FIG. 9 is a schematic illustrating an example where the object extracting unit does not couple character objects but sets different text areas;

FIG. 10 is a schematic illustrating another example where the object extracting unit does not couple character objects but sets different text areas;

FIG. 11 is a schematic illustrating an example of objects that form a schematic included in the document data shown in FIG. 5;

FIG. 12 is a schematic illustrating a procedure through which the object extracting unit groups objects, which form a schematic, by a first method;

FIG. 13 is a schematic illustrating a procedure through which the object extracting unit groups objects, which form a schematic, by a second method;

FIG. 14 is a schematic illustrating an example of a search screen displayed on a monitor by a displaying unit of the PC shown in FIG. 1;

FIG. 15 is a schematic illustrating an example of a screen on which search results are displayed by the displaying unit;

FIG. 16 is a schematic illustrating an example of a screen on which the displaying unit displays thumbnails of respective areas, when pressing a button on the screen shown in FIG. 15, or when selecting thumbnail at a display style on the screen shown in FIG. 14;

FIG. 17 is a schematic illustrating an example of a screen on which, when pressing a reference button of one of areas displayed on the screen shown in FIG. 16, the displaying unit displays details of the area;

FIG. 18 is a schematic illustrating an example of a search result screen on which, when pressing a search button on the screen shown in FIG. 16, the displaying unit displays search results for similar areas;

FIG. 19 is a schematic illustrating an example of a screen on which the displaying unit displays details of a page that satisfies search conditions;

FIG. 20 is a flowchart of a processing procedure performed by the PC shown in FIG. 1 through which an editing application program reads document data, and then registers the document data into a storage unit;

FIG. 21 is a flowchart of a processing procedure performed by the PC shown in FIG. 1 from a search request for an area in document data until display of a search result;

FIG. 22 is a flowchart of a processing procedure performed by the PC shown in FIG. 1 from a search request for a page in document data until display of a search result; and

FIG. 23 is block diagram of hardware configuration of a PC that executes a computer program to implement a function of the PC shown in FIG. 1.

### DETAILED DESCRIPTION OF THE PREFERRED EMBODIMENTS

According to an embodiment of the present invention, an information processing apparatus includes an input unit that receives input of object information and positional information for each object, where the object information is information about each of the objects rendered in a certain unit that is included in a page of document information and the positional information is information about position of each of the objects within the document information; an extracting unit that extracts objects included in an area in the document information based on the positional information; and an integrating unit that integrates extracted objects thereby creating an integrated image of the area.

According to another embodiment of the present invention, a method of processing information includes receiving input of object information and positional information for each object, where the object information is information about each of the objects rendered in a certain unit that is included in a page of document information and the positional information is information about position of each of the objects within the document information; extracting objects included in an area in the document information based on the positional information; and integrating extracted objects thereby creating an integrated image of the area.

According to another embodiment of the present invention, a computer program product comprising a computer usable medium having computer readable program codes embodied in the medium that when executed causes a computer to execute receiving input of object information and positional information for each object, the object information being information about each of the objects rendered in a certain unit that is included in a page of document information, and the positional information being information about position of each of the objects within the document information; extracting objects included in an area in the document information based on the positional information; and integrating extracted objects thereby creating an integrated image of the area.

The above and other embodiments, features, advantages and technical and industrial significance of this invention will be better understood by reading the following detailed description of presently preferred embodiments of the invention, when considered in connection with the accompanying drawings.

Exemplary embodiments of the present invention will be explained below in detail with reference to accompanying drawings.

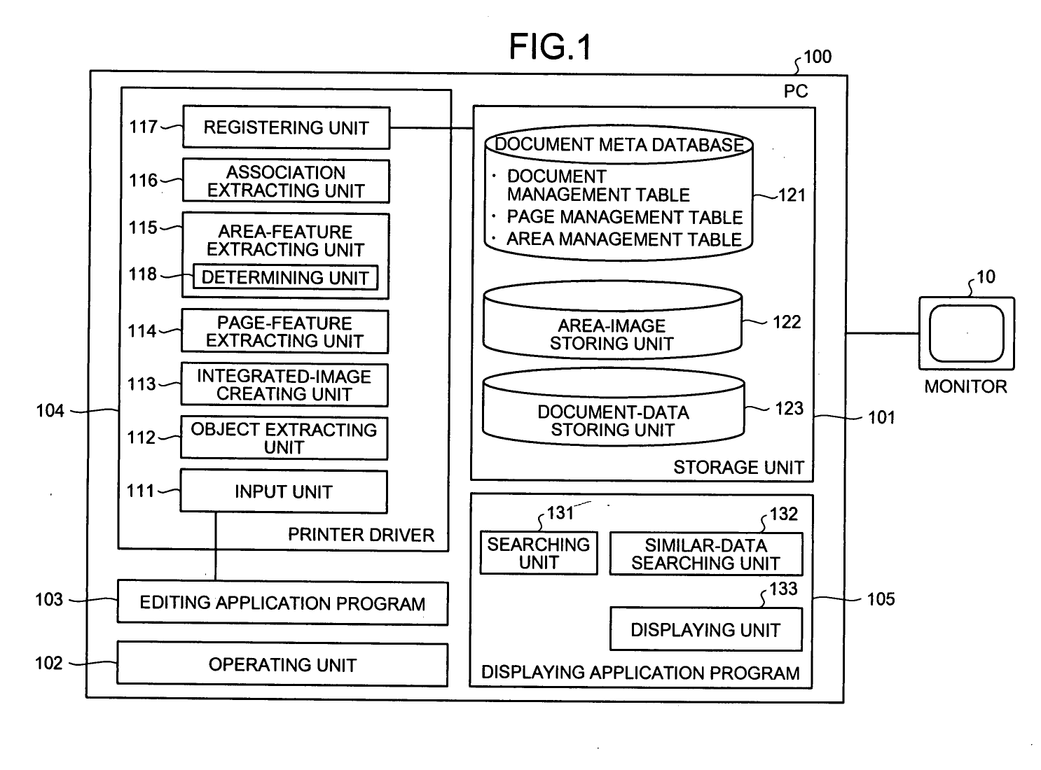

FIG. 1 is a block diagram of a personal computer (PC) 100 according to a first embodiment of the present invention. The PC 100 shown in FIG. 1 includes a storage unit 101, an operating unit 102, an editing application program 103, a printer driver 104, and a displaying application program 105. The PC 100 can manage an integrated image per area divided from document data edited and/or created by the editing application program 103.

In the first embodiment, document data subjected to editing by a user can be either a document image which presents characters as image, or an electronic document created by a document processing application program.

Document images subjected to processing include a document image created by a user, a scanned document read by a scanner, and a facsimile document received by a facsimile. Moreover, the electronic document includes a Web document created in accordance with the hypertext markup language (HTML).

In the first embodiment, when the PC 100 registers document data created, edited, and/or referred by the editing application program 103, the PC 100 uses the printer driver 104 for registration (analysis driver). The printer driver 104 does not actually print a document, but analyzes an electronic document and registers it.

In other words, the user calls a printing function of the editing application program 103 applicable to register the document data. Accordingly, the editing application program 103 creates drawing codes for printing the document into the printer driver 104 outputs the drawing codes to the printer driver 104. When the drawing codes are input, the printer driver 104 extracts integrated image data presenting images of respective areas that constitute the document by analyzing the drawing codes. The printer driver 104 then registers extracted integrated image data and document data in a searchable format into the storage unit 101.

The storage unit 101 includes a document meta database 121, an area-image storing unit 122, and a document-data storing unit 123. In addition, the storage unit 101 can be configured with any storage unit generally used, such as a hard disk drive (HDD), an optical disk, a memory card, and a random access memory (RAM).

The document meta database 121 includes a document management table, a page management table, and an area management table.

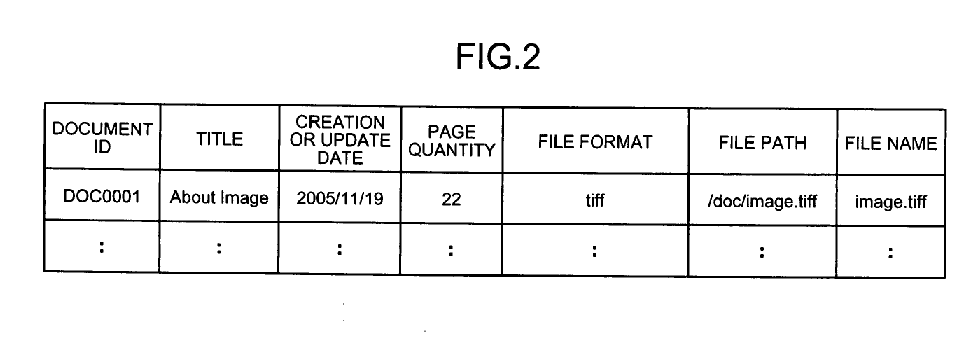

FIG. 2 is a schematic illustrating the document management table. Each record held in the document management table includes an document identification (ID), a title, an creation or update date, a page quantity, a file format, a file path, and a file name, all of which are associated each other. In the first embodiment, these information are referred to as document metadata that indicates attribution and other information of a document.

The document ID is a unique ID assigned to each document data, due to which the document data can be identified. The title is a title of the document data. The creation or update date holds a creation date or the latest update date of the document data. The page quantity holds a quantity of pages included in the document data. The file format holds a format of each document data. Due to this, a format of the document under control can be identified as one of the scanned document, the facsimile document, the electronic document created by an application program, or the Web document.

The file path indicates a location where the document data is stored. The file name presents a file name of the document data.

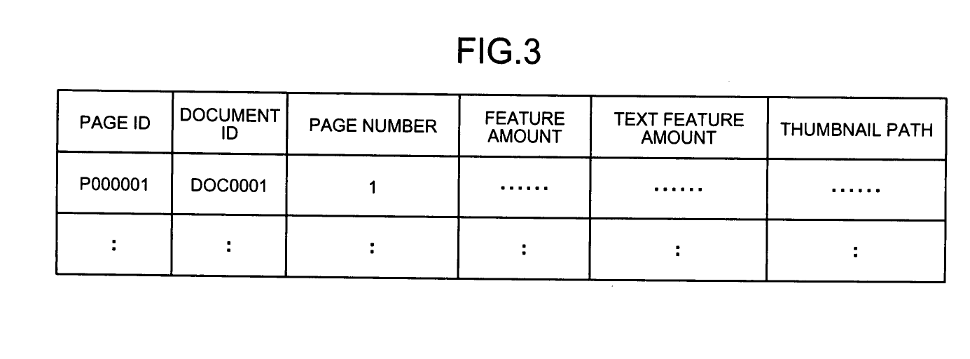

FIG. 3 is a schematic illustrating the page management table. Each record held in the page management table includes a page ID, a document ID, a page number, a feature amount, a text feature amount, and a thumbnail path, all of which are associated each other. In the first embodiment, this information is referred to as page metadata.

The page ID is a unique ID assigned to each of pages that constitutes the document data. Due to this page ID, a page in the document data present in the storage unit 101 can be uniquely identified. The document ID is an ID to identify document data that includes the page identified with the page ID. The page number is a numerical digit assigned to the page in the document. The feature amount relates to a feature extracted from the whole image of the page.

The text feature amount relates to a feature extracted from text information included in the page. For example, the text feature amount holds a key word included in the text information, and a frequency appearance of the key word. If the document data is a document image, the text feature amount is extracted from the text information that is extracted from the document image of the page by performing optical character recognition (OCR). The thumbnail path holds a location where a thumbnail that presents the whole image of the page is stored.

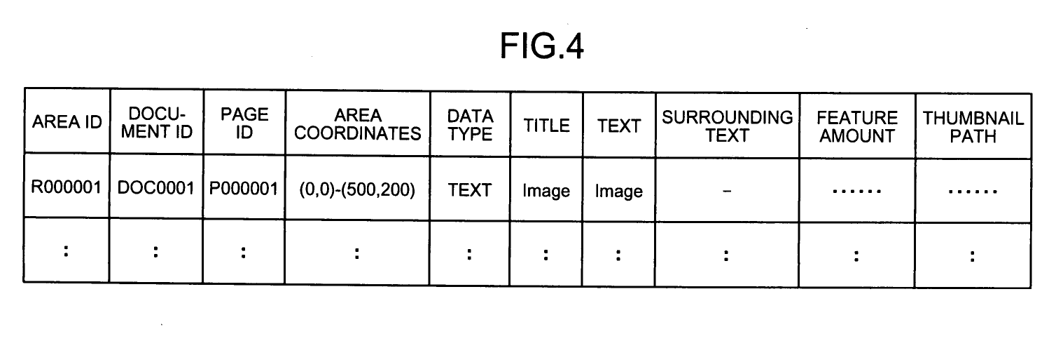

FIG. 4 is a schematic illustrating the area management table. Each record held in the area management table includes an area ID, a document ID, area coordinates, a data type, a title, a text, a surrounding text, a feature amount, and a thumbnail path, all of which are associated each other. In the first embodiment, these information are referred to herein as area metadata.

The area ID is a unique ID assigned to each area divided from document data. Due to this ID, an area included in document data present in the storage unit 101 can be identified. The document ID and the page ID mean respective IDs identifying document data and a page that include the area identified with the area ID. The area coordinates hold coordinates that identify the area. In the first embodiment, the area is identified by holding coordinates of an upper left vertex of the area and coordinates of an lower right vertex of the area.

The data type holds information that identifies a type of data in the area. Types of data include, for example, text, image, diagram (such as organization chart, flowchart, and Gannt chart), photograph, table, graph (such as pie chart, and bar chart), and the like. The title holds a title that represents the area. The text holds text information included in the area.

The surrounding text holds text information arranged around a picture, when the type of data is image, diagram, photograph, table, graph, or the like. Due to this surrounding text, the user can set a condition in text on a search screen, and search relevant images.

The feature amount holds a feature amount that identifies the area. Moreover, if the data type is image, a feature amount of an image is stored, while if the data type is text, a text feature amount is stored. Thus, the feature amount holds a different kind of feature amount in accordance with the data type. Accordingly, it can be appropriately determined whether an area is similar to another, by comparing feature amounts of the same data type. The thumbnail path holds a location where a thumbnail that presents the area is stored.

The area-image storing unit 122 stores therein an integrated image of each area divided from document data, and a thumbnail that presents a page or the area. In addition, the document-data storing unit 123 stores therein document data.

The operating unit 102 processes an operation input by the user. As a result, the user can create and/or edit document data with the editing application program 103, request the editing application program 103 to submit the document data to the printer driver 104, and set a search condition on the search screen displayed on the displaying application program 105.

The editing application program 103 performs processing, such as creating or editing the document data, in accordance with the operation processed by the operating unit 102. The document data created or edited can be displayed on a monitor 10. When the editing application program 103 receives a print request from the user for document data that the user is editing, the editing application program 103 then creates drawing codes from the document data, and outputs the drawing codes to the printer driver 104.

Data obtained as drawing codes are generally an aggregation of objects rendered in a minimum unit. An object rendered in the minimum unit is information in a minimum unit that cannot be divided any further when rendering, for example, information presenting a character, or information presenting a drawing shape, such as a circle or a line.

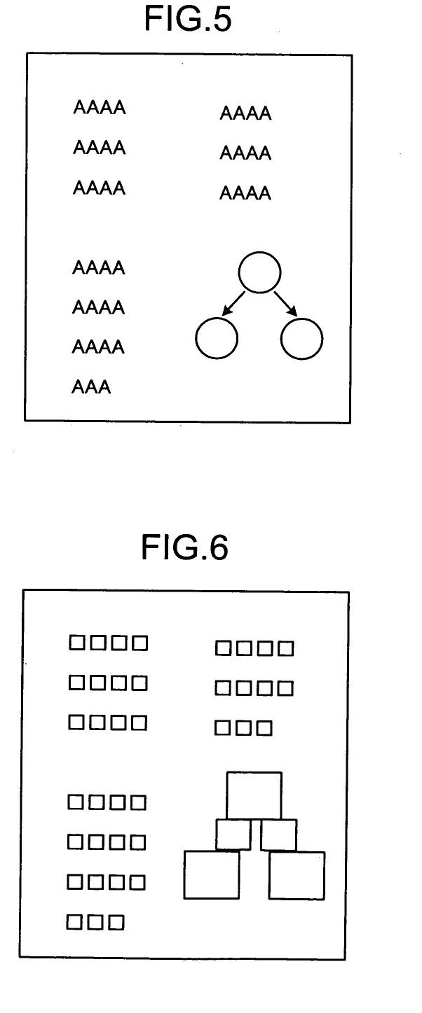

FIG. 5 is a schematic illustrating an example of document data edited by the editing application program 103. FIG. 6 is a schematic illustrating data created as drawing codes by the editing application program 103 from the document data shown in FIG. 5. The drawing codes include, a character code, a font, a font size, and information of a drawing shape (such as a circle or a line), together with information of each rectangle delimited per object. The drawing codes also include positional information within the document data. Due to the positional information, a position of an object on each page can be identified, when processing is performed within the printer driver 104.

In FIG. 1, the printer driver 104 includes an input unit 111, an object extracting unit 112, an integrated-image creating unit 113, a page-feature extracting unit 114, an area-feature extracting unit 115, an association extracting unit 116, and a registering unit 117. The printer driver 104 creates integrated image data per area divided from document data input by the editing application program 103. The printer driver 104 then registers the integrated image data into the storage unit 101 by associating with the document data.

The input unit 111 inputs drawing codes of document data to be registered by the editing application program 103.

The registering unit 117 registers input document data to be registered. In the first embodiment, the registering unit 117 creates document data from received drawing codes, and stores the document data into the document-data storing unit 123. Document data to be created can be of any data type, for example, data in the portable document format (PDF). The registering unit 117 stores metadata of the document data stored in the document-data storing unit 123 into the document management table in the document meta database 121. Specifically, the registering unit 117 extracts a title, a creation or update date, and a page quantity from the document data. The registering unit 117 then associates a document ID with extracted metadata, a file name of the document data, a file format indicated with an extension of the file name, and a file path to which the document data is stored, and stores them into the document management table. Furthermore, the document ID is automatically created when registering. In the first embodiment, the registering unit 117 creates document data, and then registers created document data. However, the registering unit 117 can directly register document data created by the editing application program 103.

In addition to document data, the registering unit 117 registers data into the page management table and the area management table.

The object extracting unit 112 extracts objects, area by area, from all objects included in input drawing codes.

To begin with, if the input drawing codes include an object presenting an image over the whole rendered page, which means that the object is rendered on the background, the object extracting unit 112 extracts the object as a component of the background.

Moreover, the object extracting unit 112 determines whether an object presents character information. The object extracting unit 112 can use any method for this determination regardless of a known method or an unknown method. If the input drawing codes include any object presenting character information (hereinafter, a character object), the object extracting unit 112 then extracts character objects text-area by text-area.

To perform this, the object extracting unit 112 needs to specify a text area. At first, the object extracting unit 112 determines a reading order of characters from character objects determined as characters. If a character object is closer to its previous character object than a predetermined spacing, the object extracting unit 112 then determines that the character object is included in the same line as its previous character object. Furthermore, if there is a character object that is not close to its previous character object in the reading order direction but closer to its previous line than a predetermined spacing, the object extracting unit 112 determines that the character object is included in the next line in the same text area (paragraph). Thus, the object extracting unit 112 can extract character objects that constitute a text area by repeating these processes. In contrast, the object extracting unit 112 determines that a character object that is close to neither its previous character nor its previous line is a component of a next text area (paragraph).

The above predetermined character spacing and the predetermined line spacing are predetermined distances based on a font size included in the input drawing codes. For example, it is conceivable that a predetermined character spacing and a predetermined line spacing can be a font size or a value (L1) of a font size multiplied by an appropriate coefficient.

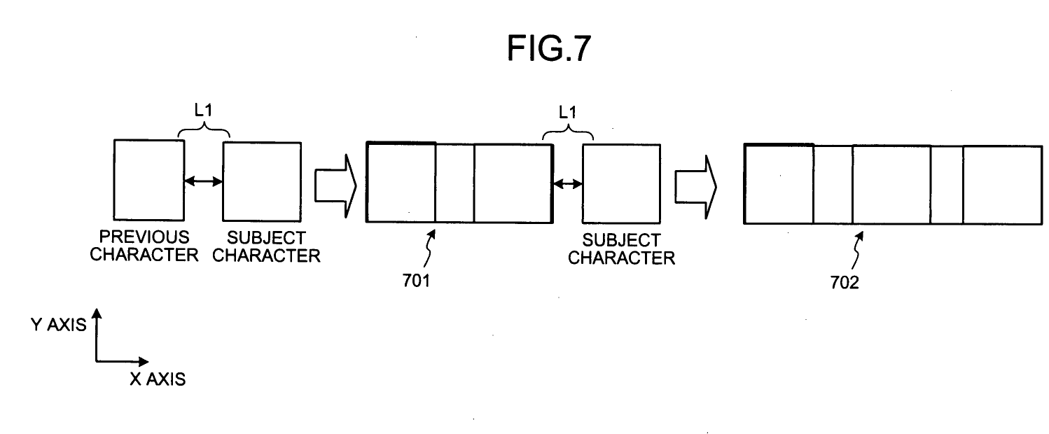

FIG. 7 is a schematic illustrating a coupling process of coupling character objects included in the same line. If a distance between character objects in an x axis direction (horizontal direction) is shorter than a distance between character objects in a y axis direction (vertical direction), the object extracting unit 112 determines that the x axis direction is the reading order direction. As a result, if the distance between the character objects is shorter than L1, as shown in FIG. 7, the object extracting unit 112 determines that the characters are adjacent, and merges them into a line rectangle (for example, merging characters into a line rectangle 701, and further into a line rectangle 702).

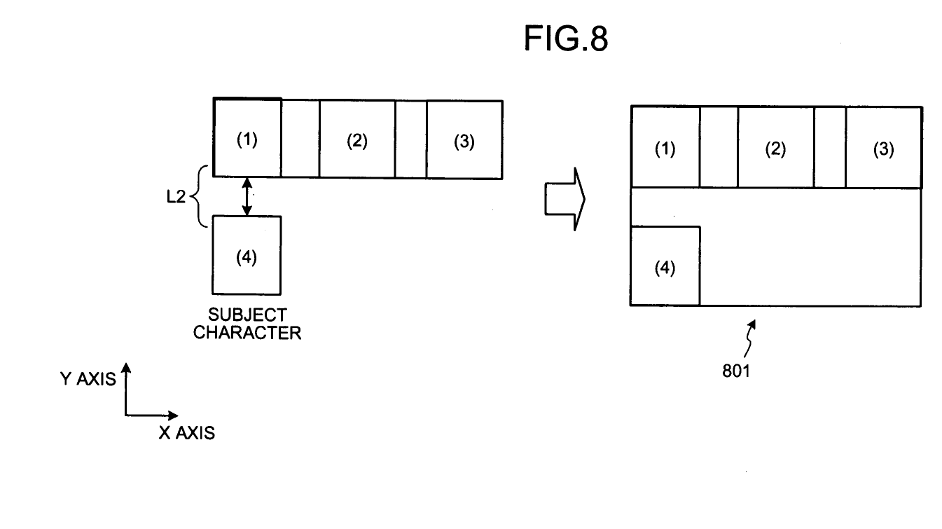

FIG. 8 is a schematic illustrating a coupling process of coupling character objects included in different lines. After merging character objects into a line rectangle in the x axis direction, if a distance between the line rectangle and a character object in the y axis direction is shorter than L2, which is multiplied by an appropriate coefficient in order to be longer than L1, the object extracting unit 112 merges the character as a different line but into a same text area (for example, a text area 801) with the line rectangle.

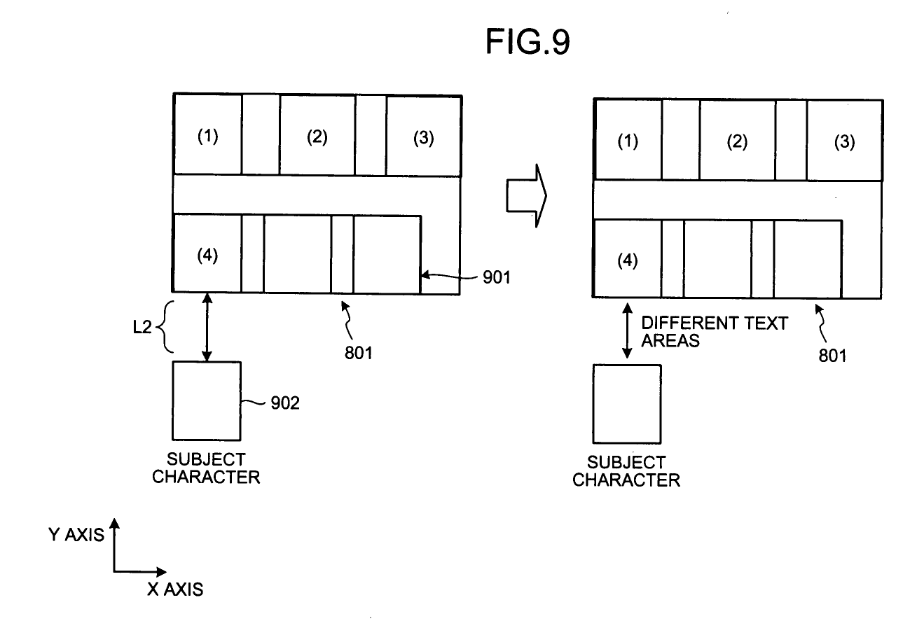

FIG. 9 is a schematic illustrating an example where the object extracting unit 112 does not couple character objects but sets different text areas. If a distance between a rectangle 901 merged into the text area 801 and a character object 902 in the y axis direction is longer than L2, the object extracting unit 112 determines that the character object 902 is in a different text area.

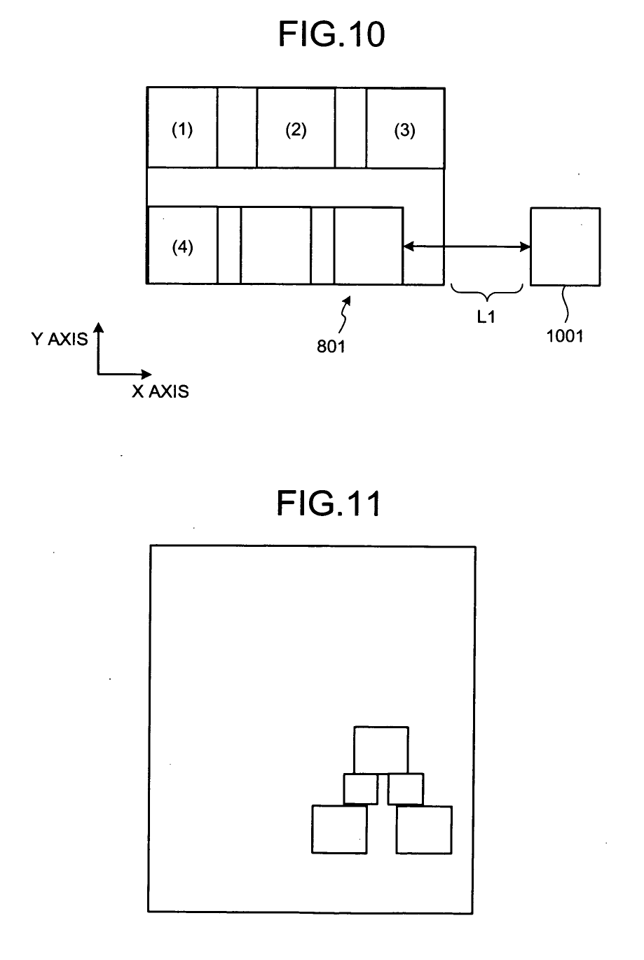

FIG. 10 is a schematic illustrating another example where the object extracting unit 112 does not couple character objects but sets different text areas. If a distance between an edge line of the text area 801 perpendicular to the x axis and an edge line of a rectangle of a character object 1001 is longer than L1, the object extracting unit 112 determines that the character object 1001 is in a different text area.

By performing the above processing, the object extracting unit 112 can determine the text area included in the document data from the input drawing data. This enables the object extracting unit 112 to extract character objects included in the text area, thereby creating an integrated image with respect to each text area.

Next, the object extracting unit 112 extracts objects included in an area other than the text area. An area other than the text area included in document data can be an image area, a diagram area, a graph area, a photograph area, or the like. The object extracting unit 112 extracts objects area by area of an image, a diagram, or the like, from input drawing data.

In other words, the object extracting unit 112 acquires each of the objects that form an image, a diagram, or the like, in a separated form from input drawing codes. Each of these objects presents, for example, a line or a circle, but each single object has no meaning. Therefore, the object extracting unit 112 performs processing to extract an area, such as a diagram area, that has meaning.

The object extracting unit 112 according to the first embodiment can perform two kinds of processing for extracting objects area by area. As a first method, if each rectangle that includes each object is superimposed with another rectangle, the object extracting unit 112 groups such superimposed objects as an area, and then extracts the objects.

FIG. 11 is a schematic illustrating an example of objects that form a schematic included in the document data shown. When the objects are input by the input unit 111, each of the objects is in a separated form. Moreover, when the objects are input, a position of each object to be arranged on a page is specified with positional information of each of the objects.

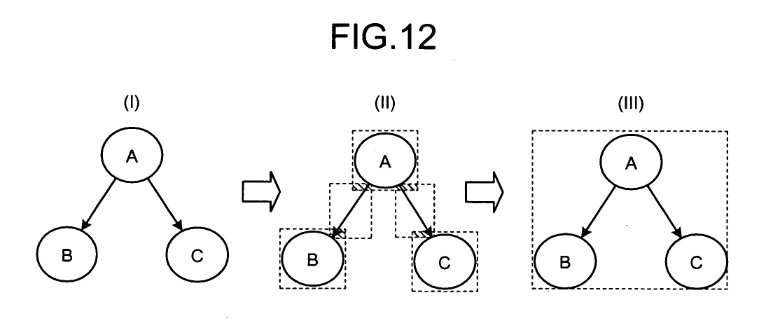

FIG. 12 is a schematic illustrating a procedure through which the object extracting unit 112 groups objects, which form a schematic, by the first method. Suppose a schematic shown in section (I) in FIG. 12 is created by using the editing application program 103. The user then requests printing, as a result, when the printer driver 104 is called, created schematic is divided into each object as shown in section (II) in FIG. 12.

After these objects are input, the object extracting unit 112 refers to positional information of the objects and then determines whether areas are superimposed between the objects. If some areas are superimposed, the object extracting unit 112 determines that the objects form non-text areas (for example, a diagram or an image), and then groups the objects as shown in section (III) in FIG. 12.

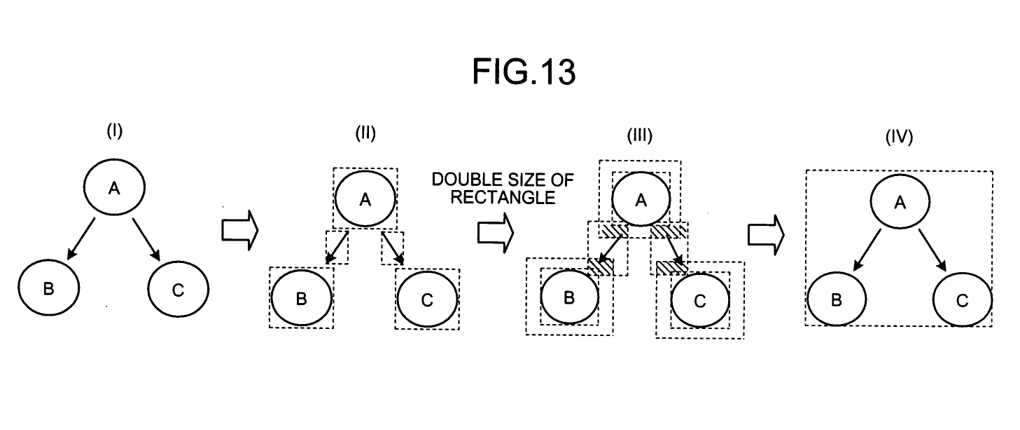

A second method is a method of grouping objects when the objects are not superimposed each other. FIG. 13 is a schematic illustrating a procedure through which the object extracting unit 112 groups objects, which form a schematic, by the second method. Suppose a schematic shown in section (I) in FIG. 13 is created by using the editing application program 103. The user then requests printing, as a result, when the printer driver 104 is called, created schematic is divided into each object as shown in section (II) in FIG. 13.

After these objects are input, the object extracting unit 112 refers positional information of the objects and then determines that no area is superimposed between the objects. In this case, the objects are not grouped by the first method. The object extracting unit 112 then creates an extended area doubled in size for each rectangle which includes each object, shown in section (III) FIG. 13, and then determines whether created areas are superimposed. If some areas are superimposed, the object extracting unit 112 determines that the objects originating superimposed areas form non-text areas, and then groups the objects as shown in section (IV) in FIG. 13. When performing such processing, the object extracting unit 112 can confirm that target objects form a diagram, a graph, or the like (i.e., not font data, for example).

The object extracting unit 112 then can extract grouped objects, and can pass an integrated image to the integrated-image creating unit 113, thereby creating an image for each area.

Furthermore, when a non-text area is superimposed with the above text area, the object extracting unit 112 deems the text area as a part of the non-text area, and then merges the text area and the non-text area.

Thus, the object extracting unit 112 can define a non-text area, and can extract objects included in the non-text area. A non-text area can include a picture of various types, such as: diagram (organization chart, flowchart, Gannt chart, and the like), photograph, table, and graph (pie chart, bar chart, and the like). The data type of the non-text area can be determined to a certain extent based on features of objects included in the non-text area.

In addition, objects that are created when requesting printing often include information that specifies a shape, such as vector information indicating line segment. In this case, determination of the data type of a non-text area based on objects included in the non-text area is more precise than determination of the data type merely based on image data of an area. Therefore, a determining unit 118 included in the area-feature extracting unit 115 determines the data type of each area.

In FIG. 1, the area-feature extracting unit 115 includes the determining unit 118, and extracts a feature amount, area by area, based on objects included in each area.

A feature amount that the area-feature extracting unit 115 extracts can be, for example, one or more of the following: the quantity of objects included in each area, an average surface-area of object rectangles per surface-area of non-text rectangles, the quantity of line segment objects per total quantity of objects, the quantity of circles or arcs per total quantity of objects, the quantity of horizontal line-segment objects per total quantity of line-segment objects, the quantity of vertical line-segment objects per total quantity of line segment objects, the quantity of image objects per total quantity of objects, and the like. As a matter of course, a parameter other than the above can be used as a feature amount to be extracted.

The determining unit 118 determines the data type of an area by performing pattern recognition based on extracted feature amount. Any method of pattern recognition can be used, for example, the neural network, or the support vector machine. Due to the use of the neural network or the support vector machine, a data set for learning is created and learned, so that more a precise determination of area recognition can be achieved.

Thus, the feature amount based on the objects include detailed information as described above, so that the determining unit 118 can determine the data type of an area more precisely. This makes it easy for the user to narrow down to the integrated images that present a desired area, with reference to the data type.

In addition to the feature amount described above, the area-feature extracting unit 115 extracts a different feature amount in accordance with the data type determined by the determining unit 118. For example, if the data type in an area is determined to be an image, the area-feature extracting unit 115 extracts a feature amount of image data.

If a determined data type in an area is a document, the area-feature extracting unit 115 can acquire character information included in the area from data, such as font data included in a character object. The area-feature extracting unit 115 then extracts a text feature amount from acquired character information. In this way, the extracted feature amount, in accordance with the data type of each area is registered into the area management table.

Furthermore, if an object included in the area is image data that presents a document, the area-feature extracting unit 115 acquires text data included in the area by using OCR. The area-feature extracting unit 115 then extracts a feature amount from acquired text data.

Moreover, the area-feature extracting unit 115 extracts a title and a text per each divided area, if possible. Furthermore, if the data type of a divided area is determined to be an image, the area-feature extracting unit 115 extracts a surrounding text, if possible. Any method can be used for the area-feature extracting unit 115 to extract a title, text, and text surrounding the subject area; however, the following method is used according to the first embodiment.

To begin with, an example of extracting a title is explained below. If the subject area is an image area, the area-feature extracting unit 115 acquires text included in the image area or a character string included in a text area surrounding to the image, as the title.

If the data type of the subject area is text, the area-feature extracting unit 115 extracts an appropriate character string as the title by taking into account a weight and other aspects.

The text feature amount according to the first embodiment is vector (array) data created as a feature amount from text extracted from objects included in a subject page. In other words, the page-feature extracting unit 114 extracts words by performing morphological analysis on text data included in the subject page. By calculating a weight with respect to each extracted word, the page-feature extracting unit 114 then creates vector data that indicates to what extent each keyword is relevant.

Any method of weighting extracted word can be used. In the first embodiment, a weight is calculated by the tf-idf method. The tf-idf method is a way for weighing words based on how many times a word appears in the subject page (more frequent appearance is deemed as more significant), and how many pages the word appears in the all data under control (less frequent appearance is deemed as more significant).

The following equation (1) is a formula of weighing by tf-idf method:

w_{i,j}=tf_{i,j}× log(N/dfᵢ) (1)

where w_{i,j} indicates a weight of a word in page Dᵢ in document data, tf_{i,j} indicates a frequency of the word in page Dᵢ, dfᵢ indicates a quantity of pages in all document data on which the word appears, and N indicates the total quantity of pages included in document data under control. Thus, the page-feature extracting unit 114 can extract a text feature amount per page based on an array of a word and a word weight.

The integrated-image creating unit 113 creates integrated image data, area by area, from objects extracted from each area by the object extracting unit 112. In addition, the integrated-image creating unit 113 creates a thumbnail that presents the area. The area-image storing unit 122 then stores therein the created thumbnail.

The association extracting unit 116 extracts an association between the integrated image data created by the integrated-image creating unit 113 with respect to each of areas, document data that includes the areas, and a page on which the areas are arranged. The association extracting unit 116 according to the first embodiment extracts coordinates of each area on the page, a page ID indicating the page including data of each of the areas, and a document ID of a document including the page. Due to this extraction, the association extracting unit 116 can identify at which position, on which page, and in which document, created integrated image data is present. Moreover, the association extracting unit 116 can identify coordinates of each area on the page from input positional information of each object.

After that, the registering unit 117 registers the association extracted by the association extracting unit 116, the integrated image data created by the integrated-image creating unit 113, and the data type and the feature amount extracted by the area-feature extracting unit 115, into the area management table. More specifically, the registering unit 117 associates an area ID with a document ID, a page ID, and area coordinates extracted by the association extracting unit 116, a data type, a text, a surrounding text, a feature amount, and a thumbnail path extracted by the area-feature extracting unit 115, and registers them into the area management table. The area ID is automatically created when above information of the area is registered into the area management table.

The page-feature extracting unit 114 extracts a feature amount of image of each page from objects that form each page in input document data. The page-feature extracting unit 114 can use any method of extracting a feature amount, and also can use a neural network or a support vector machine.

Moreover, the page-feature extracting unit 114 extracts a page number and a text feature amount from each page, in addition to the feature amount of image. Furthermore, the page-feature extracting unit 114 extracts text information from data, such as font data, included in objects. The page-feature extracting unit 114 then extracts a text feature amount from extracted text information.

In addition, the page-feature extracting unit 114 creates a thumbnail that presents the page. The area-image storing unit 122 then stores therein created thumbnail.

Metadata extracted by the page-feature extracting unit 114 is then registered into the page management table by the registering unit 117. In other words, the registering unit 117 associates a page ID and a document ID with a page number, a feature amount, a text feature amount, and a storage location of thumbnail (thumbnail path), and registers them into the page management table. The document ID is an ID that is created when document data that includes the subject page is registered into the document management table. The page ID is automatically created when the above information of the subject page is registered into the page management table.

The displaying application program 105 includes a searching unit 131, a similar-data searching unit 132, and a displaying unit 133, and performs processing of displaying and searching data, such as document data present in the storage unit 101.

The displaying unit 133 performs processing of the display of a search screen or a search result onto the monitor 10. The searching unit 131 searches the document management table, the page management table, and the area management table, in the document meta database 121, in response to a search request for document data.

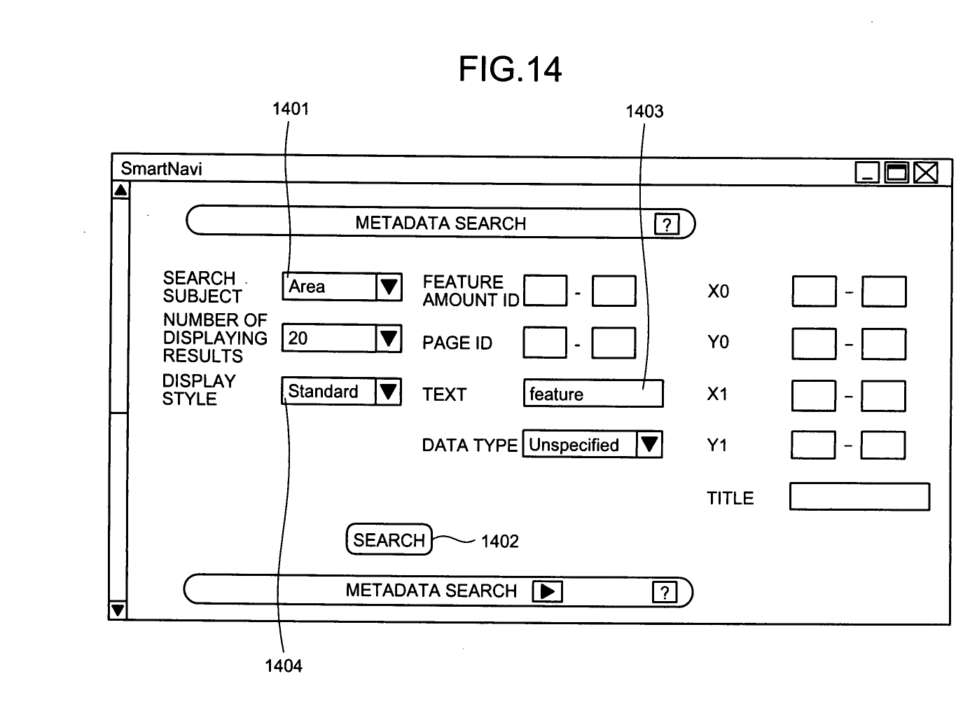

FIG. 14 is a schematic illustrating an example of a search screen displayed on the monitor 10 by the displaying unit 133. The search screen is displayed when the user searches a document. On the search screen, items for setting search conditions are displayed. A search item 1401 is an item at which the user selects a search subject from document, page, or area. In FIG. 14, an area is selected as the search item. A display style 1404 is an item at which the user selects a display style from standard, thumbnail, tree, or the like. In FIG. 14, a standard style is selected.

In accordance with an input, for example, from a not-shown keyboard by the user, the operating unit 102 sets a search condition to each item displayed on the search screen. When the operating unit 102 receives a press of a search button 1402 from the user, the operating unit 102 calls the displaying application program 105, and passes the set search conditions. In FIG. 14, “feature” is input into a text 1403 as a search condition, as an example. Accordingly, the searching unit 131 performs a search.

After the displaying application program 105 receives a search condition, the searching unit 131 searches an applicable table based on received search condition. Specifically, if document is selected at the search item 1401 shown in FIG. 14, the searching unit 131 searches the document management table. If page is selected, the searching unit 131 searches the page management table. If area is selected, the searching unit 131 searches the area management table. In addition, the searching unit 131 performs a search based on the received search condition as a searching key. This enables the searching unit 131 to acquire integrated image data that presents document data desired by the user, or a page or an area included in the document data. Accordingly, the PC 100 can efficiently detect information of an area or a page as required by the user.

The displaying unit 133 then performs processing of the display of a search result obtained by the searching unit 131 and a search result obtained by the similar-data searching unit 132.

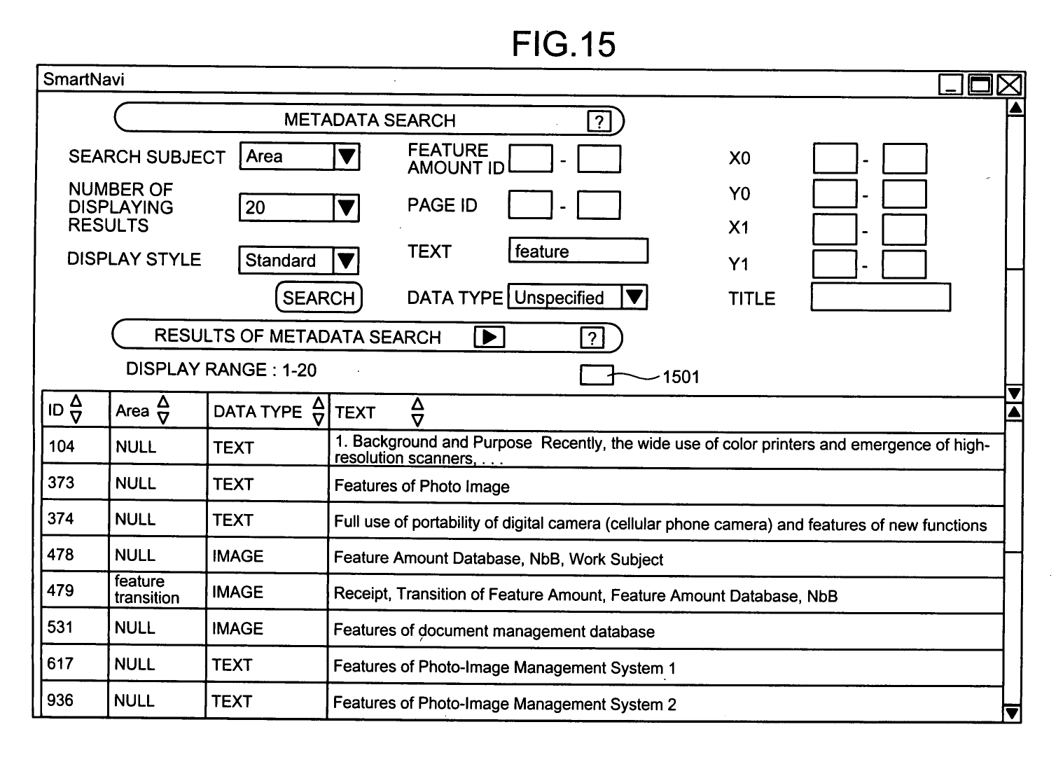

FIG. 15 is a schematic illustrating an example of a screen on which search results are displayed by the displaying unit 133. The search result screen presents the example of search results when the search subject is area, and “feature” is set in the text on the search screen shown in FIG. 14. In this case, the display style is standard. Any item can be displayed as a search result. In the first embodiment, this example displays an area ID, an area name (title), a data type, and a text.

When the search result screen shown in FIG. 15 is displayed, the user clicks the area name, and then a screen that presents detailed information of the area is displayed. Moreover, when the user press a button 1501, the displaying unit 133 displays the search result based on the same conditions in the form of a thumbnail of each area. In other words, the display style can be changed easily.

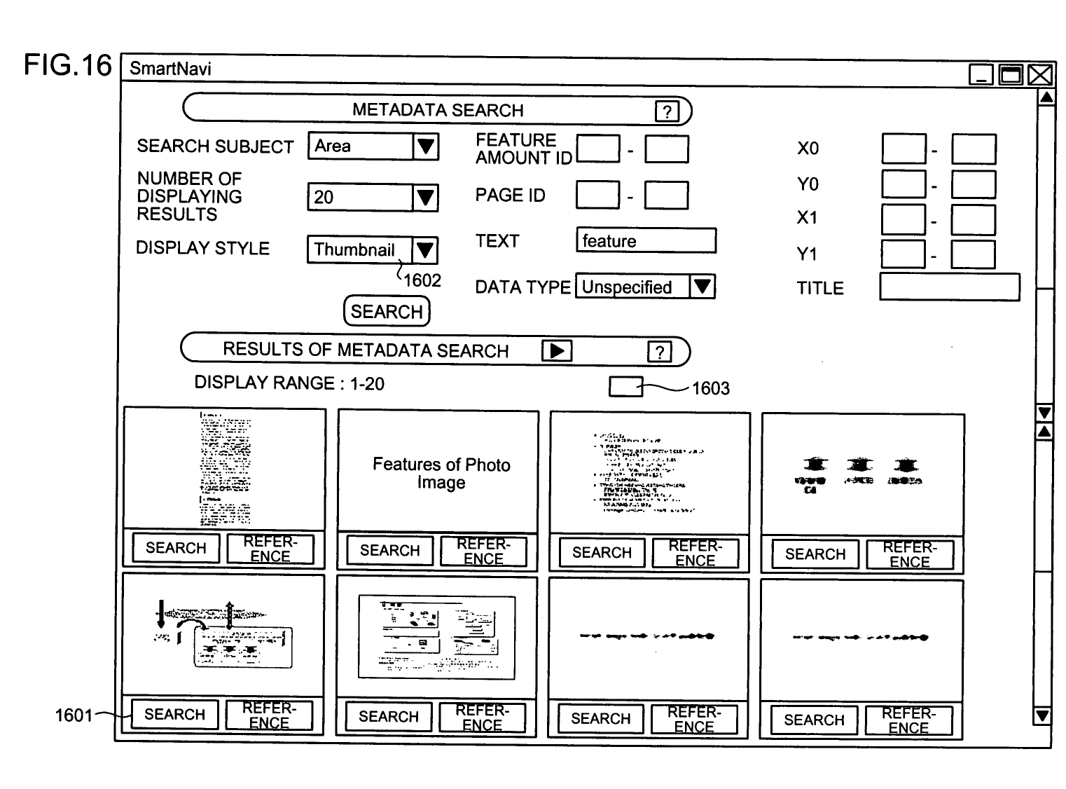

FIG. 16 is a schematic illustrating an example of a screen on which the displaying unit 133 displays thumbnails of respective areas, when pressing the button 1501 on the screen shown in FIG. 15, or when selecting thumbnail at the display style on the screen shown in FIG. 14. At a display style 1602, the display style selected by the user is presented. The displaying unit 133 displays a search button and a reference button for each area on the search result screen. When the user presses a search button, areas similar to the area of pressed search button are searched. When the user presses a reference button, the displaying unit 133 displays detailed information of the area of pressed reference button. When the user presses a button 1603, the screen shown in FIG. 15 is displayed again. Thus, the thumbnail of each area is displayed shown in FIG. 16, so that the user can easily grasp contents of each area.

A process of displaying from the screen shown in FIG. 15 to the screen shown in FIG. 16 is explained below. When the button 1501 is pressed on the screen shown in FIG. 15, the operating unit 102 passes a flag to the displaying application program 105 in order to display search conditions and thumbnails. After the displaying application program 105 receives this information, the searching unit 131 performs a search based on the search conditions. A difference between this search and the search previously described above is that the searching unit 131 acquires field information of each thumbnail path, when searching the area management table in response to the flag for displaying thumbnails. The displaying unit 133 then displays the search result screen based on the search result, together with each thumbnail per area created with the thumbnail path.

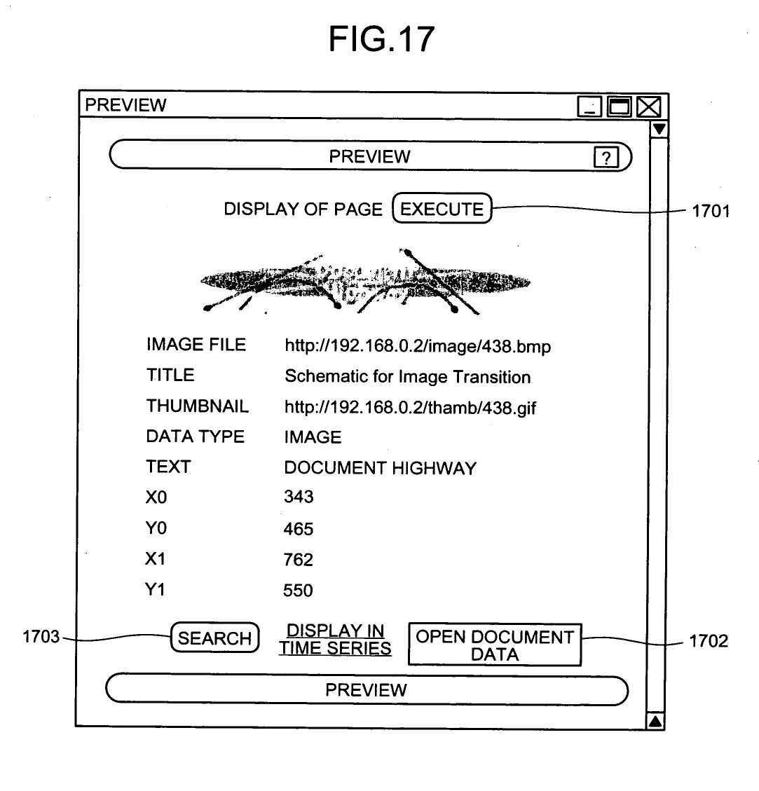

FIG. 17 is a schematic illustrating an example of a screen on which the displaying unit 133 displays details of an area, when pressing a reference button of one of areas displayed on the screen shown in FIG. 16. On such detail displaying screen, the displaying unit 133 displays metadata of the area held in the area management table. Due to this detailed display, the user can grasp the area.

A process of displaying from the screen shown in FIG. 16 to the screen shown in FIG. 17 is explained below. When a reference button is pressed on the screen shown in FIG. 16, the operating unit 102 passes information to the displaying application program 105 in order to display the area ID and details of the area of pressed reference button. After the displaying application program 105 receives this information, the searching unit 131 searches the area management table with received area ID as a search key. The displaying unit 133 then acquires all field information needed for displaying a record that satisfies search conditions. The displaying unit 133 performs processing of the display of detailed information onto the monitor 10 based on acquired information.

Furthermore, the detail displaying screen shown in FIG. 16 can display metadata of a document image or a page that includes the area in addition to the metadata of the area. This can be achieved, because the area management table holds association between the area, the page, and the document image each other.

In addition, when the user presses an execution button 1701 on the screen shown in FIG. 17, a screen that includes a thumbnail and metadata of the page to which the area belongs is displayed. This can be achieved, because the area management table holds an association between the area ID and the page ID. In other words, the reason for this is that, after the searching unit 131 acquires the page ID of the area, by searching the page management table with the page ID as a key, the searching unit 131 can acquire necessary information for display.

Furthermore, when the user presses an “open document-data” button 1702 on the screen shown in FIG. 17, document data that includes the area is displayed. The document data can be edited. This can be achieved, because the area management table holds association between the area ID and the document ID. In other words, the reason for this is that, after the searching unit 131 acquires the document ID of the area, by searching the document management table with the document ID as a key, the searching unit 131 can acquire the path of a storage location of the document.

Moreover, by pressing a search button 1703, the user can search for other areas similar to the area.

In FIG. 1, the similar-data searching unit 132 searches for areas similar to the area displayed by the displaying unit 133. In addition, the similar-data searching unit 132 searches for similar pages likewise. The similar-data searching unit 132 can use any method of area and page searching. In the first embodiment, the similar-data searching unit 132 uses feature amounts held in the area management table, or feature amounts held in the document management table, for a search.

Specifically, to begin with, the similar-data searching unit 132 acquires a feature amount associated with submitted page ID or area ID, and sets the acquired feature amount as a search condition. For example, if received information is an area ID, the similar-data searching unit 132 searches the area management table with the area ID to acquire a feature amount associated with the area ID. Likewise, the similar-data searching unit 132 can acquire a feature amount associated with the page ID from the page management table.

The similar-data searching unit 132 then searches the area management table or the page management table with set search conditions. In a specific example, the similar-data searching unit 132 calculates the similarity from the feature amount set as the search condition and the feature amount of each record, and then acquires a similar area or a similar page based on the similarity. In the first embodiment, when calculating similarity, a weight to a parameter can be changed. Regardless of known or unknown, any method of calculating similarity can be used.

Based on a search result acquired by the similar-data searching unit 132, the displaying unit 133 then performs processing of displaying the search result onto the monitor 10.

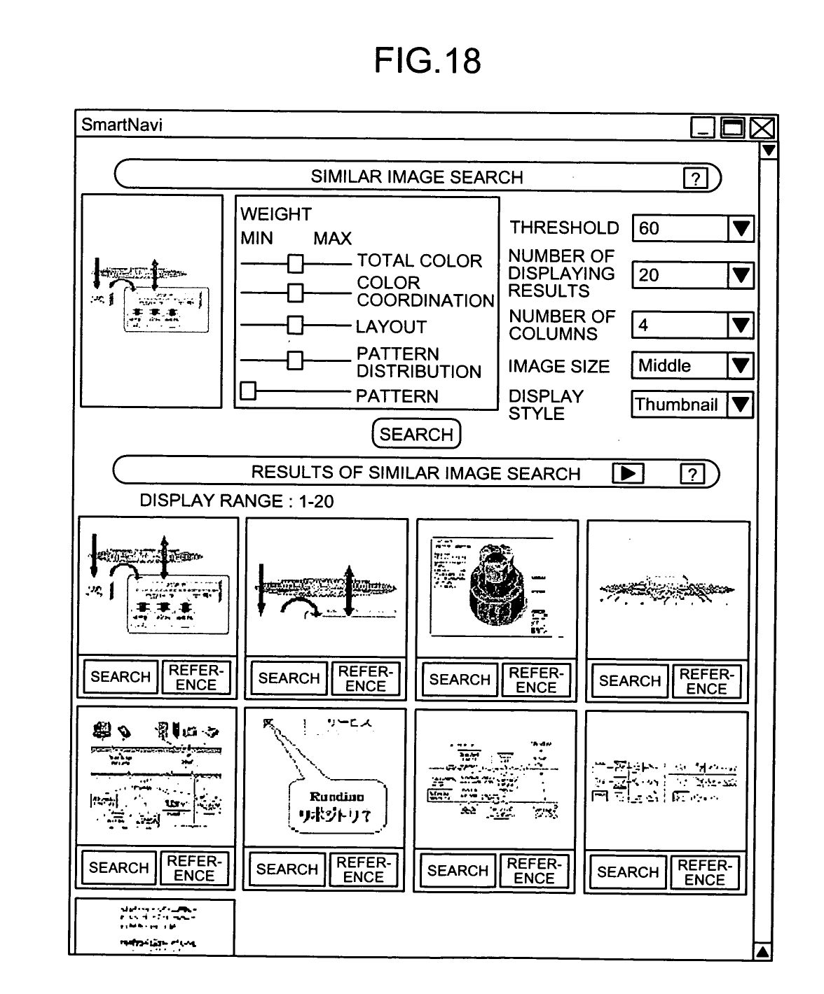

FIG. 18 is a schematic illustrating an example of a search result screen on which the displaying unit 133 displays a search result for similar areas, when pressing a search button 1601 on the screen shown in FIG. 16. The displaying unit 133 performs processing of displaying an original reference area for searching onto an upper section of a Web browser, and then performs processing of displaying a searched similar area onto a lower section. Weighting or the display style for images of similar areas can be changed in the upper section. The display style can be selected from thumbnail, tree, or the like. In FIG. 18, the display style is set to thumbnail.

When displaying a page in detail, the displaying unit 133 performs processing of the display of page information that is reproduced by combining integrated image data of respective areas.

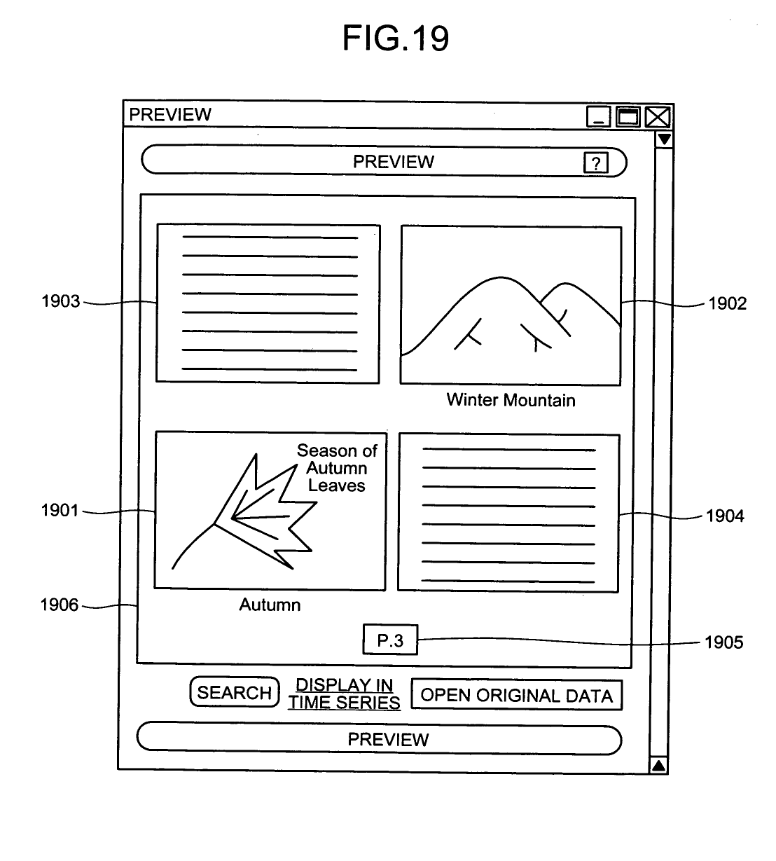

FIG. 19 is a schematic illustrating an example of a screen on which the displaying unit 133 displays details of a page that satisfies search conditions. A page 1906 is materialized by combining integrated image data 1901, 1902, 1903, 1904, and 1905. Each of the integrated image data 1901 and 1902 presents a photograph. Each of the integrated images 1903, 1904, and 1905 presents a text area.

The displaying unit 133 arranges these integrated image data within the page 1906 in accordance with coordinates held in the area management table to perform display processing. This enables the PC 100 to reduce data volume to be stored in the storage unit 101, because the storage unit 101 does not need to hold detailed image data of each page.

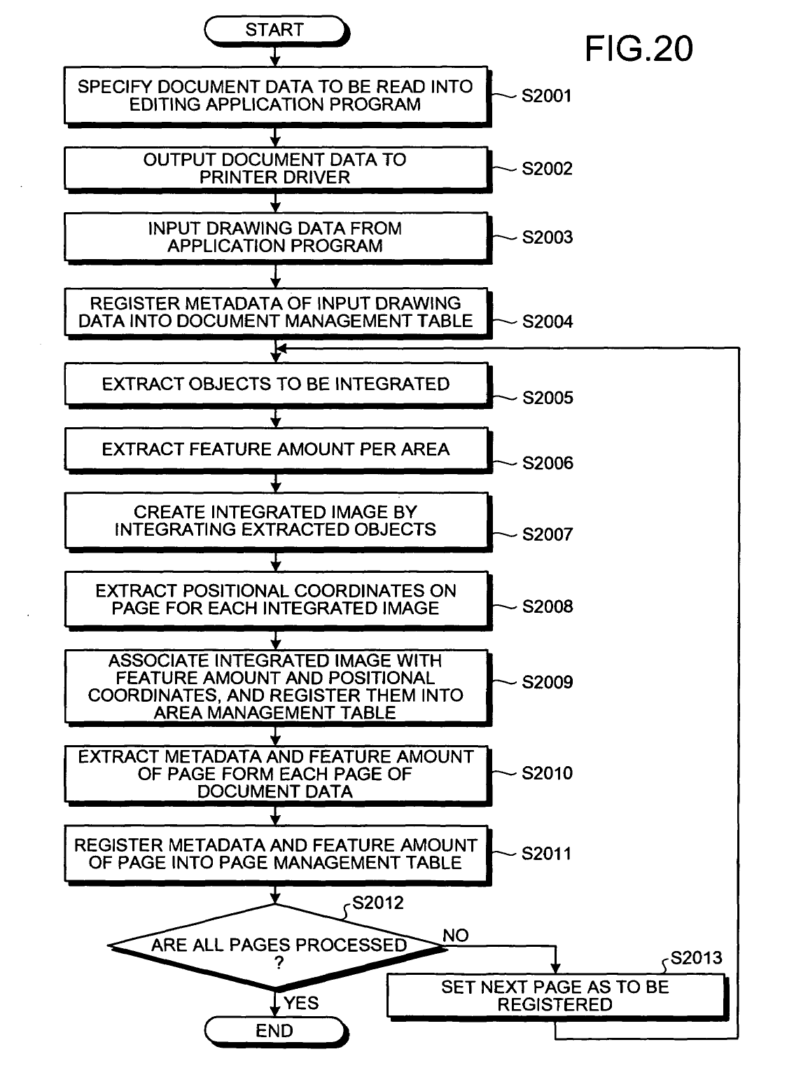

FIG. 20 is a flowchart of the processing performed by the PC 100, and specifically, a process from reading document data into the editing application program 103 until registering the document data into the storage unit 101.

To begin with, the operating unit 102 specifies document data specified by the user from an input device, such as a keyboard, and the editing application program 103 reads specified document data (step S2001).

Next, when receiving a print request from the user, the editing application program 103 creates drawing data that presents read document data, and outputs the drawing data to the printer driver 104 (step S2002).

The input unit 111 then inputs the drawing data (step S2003).

Next, the registering unit 117 creates document data from input drawing data, stores created document data into the document-data storing unit 123, extracts metadata from the document data, and registers extracted metadata and a path to the document data into the document management table (step S2004).

The object extracting unit 112 then extracts objects area-by-area from the drawing data (step S2005).

Next, the area-feature extracting unit 115 extracts a feature amount per area from extracted objects per area (step S2006). At the same time, the determining unit 118 determines a data type of each area.

The integrated-image creating unit 113 then creates integrated image data from the objects per area (step S2007).

Next, the association extracting unit 116 extracts positional relation of each integrated image data in page from the integrated image data per area and the document data that includes the area of the integrated image data (step S2008). Examples of extracted information for the positional relation are a document ID, a page ID, and coordinates in the page.

The registering unit 117 then associates the feature amount per area with the positional relation, and registers them into the area management table (step S2009).

Next, the page-feature extracting unit 114 extracts metadata, a feature amount of the page as image, and a text feature amount from objects that form each page of the document data (step S2010). The registering unit 117 then registers the metadata, the feature amount of the page, and the text feature amount into the page management table (step S2011).

Next, the registering unit 117 determines whether the processing is finished on all pages (step S2012). If the registering unit 117 determines that the processing is not finished (No at step S2012), the registering unit 117 sets a next page in order to be registered (step S2013), and then the processing is performed from extraction of objects per area performed by the object extracting unit 112 (step S2005).

If the registering unit 117 determines that the processing is finished (Yes at step S2012), the processing is ended.

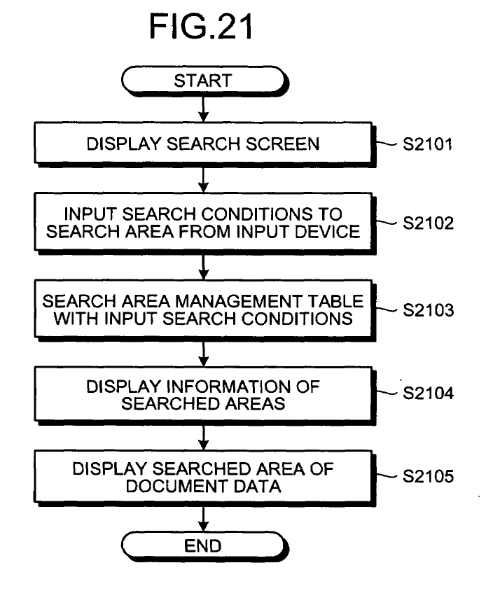

FIG. 21 is a flowchart of the processing performed by the PC 100, and specifically, a process from a search request for an area in document data until displaying a search result.

The displaying unit 133 performs processing of the display of the search screen onto the monitor 10 (step S2101). The operating unit 102 then inputs search conditions input by the user via the input device to search an area (step S2102). In the example shown in FIG. 14, the operating unit 102 sets the search item 1401 to area to select area as a search condition.

Next, the searching unit 131 searches the area management table with input search conditions (step S2103).

The displaying unit 133 then performs processing of the display of search results onto the monitor 10 (step S2104).

Next, when receiving a request to display document data from the user, the displaying unit 133 then performs processing of displaying requested area of the document data (step S2105).

Thus, an area included in document data can be searched in accordance with search conditions set by a user.

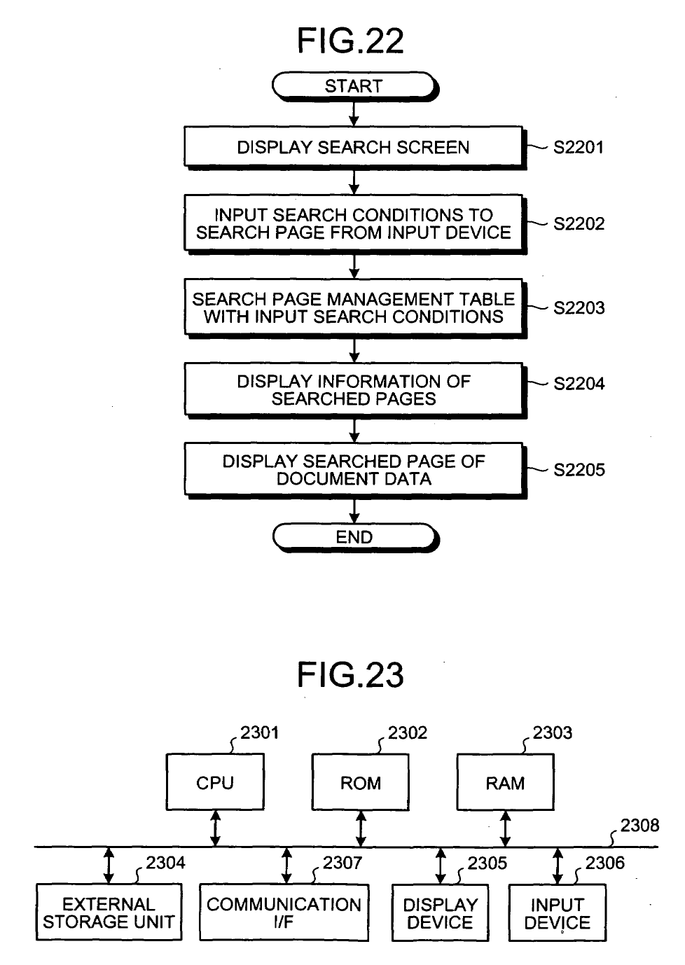

FIG. 22 is a flowchart of the processing performed by the PC 100, and specifically, a process from a search request for a page in document data until displaying a search result.

The flowchart of page search shown in FIG. 22 is substantially similar to the flowchart of area search shown in FIG. 21. Differences in FIG. 22 from FIG. 21 are as follows: the search conditions for searching for an area at step S2102 in FIG. 21 is replaced with search conditions for searching for a page at step S2202; and the search through the area management table at step S2103 in FIG. 21 is replaced with a search through the page management table at step S2203. Explanations for the other embodiments similar to FIG. 21 are omitted.

FIG. 23 is block diagram of the hardware configuration of a PC that executes a computer program to implement a function of the PC 100. The PC 100 according to the first embodiment includes a control unit, such as a central processing unit (CPU) 2301, storage devices, such as a read-only memory (ROM) 2302 and a random access memory (RAM) 2303, an external storage device 2304, such as a hard disk drive (HDD) or a compact disc (CD) drive device, a display device 2305, an input device 2306, such as a keyboard or a mouse, a network interface (I/F) 2307 through which the PC 100 can communicate with another computer, and a bus 2308 that connects these units. The PC 100 has a hardware configuration using a general computer.

Information processing programs, such as a printer driver and a displaying application program, to be executed by the PC 100 are provided in the form of a file in an installable or executable format that is recorded on a computer-readable recording medium, such as a CD-ROM, or a digital versatile disc (DVD).

Moreover, the information processing programs can be provided by storing the programs on a computer connected to a network, such as the Internet, to be downloaded via the network. Furthermore, the information processing programs can be provided or distributed via a network, such as the Internet.

Moreover, the information processing programs can be provided by pre-installing the programs onto a storage device, such as a ROM.

The printer driver to be executed on the PC 100 has a module configuration that includes each unit described above, namely, the registering unit, the association extracting unit, the area-feature extracting unit, the page-feature extracting unit, the integrated-image creating unit, the object extracting unit, and the input unit. In terms of actual hardware, the CPU reads the information processing programs from the storage device, and executes the programs, so that the registering unit, the association extracting unit, the area-feature extracting unit, the page-feature extracting unit, the integrated-image creating unit, the object extracting unit, and the input unit are created on a main memory.

The displaying application program to be executed on the PC 100 has a module configuration that includes each unit described above, namely, the searching unit, the similar-data searching unit, and the displaying unit. In terms of actual hardware, the CPU reads the information processing programs from the storage device, and executes the programs, so that each unit is loaded on the main memory, then the searching unit, the similar-data searching unit, and the displaying unit are created on the main memory.

In the first embodiment, each table for document, page, and area are stored into the document meta database constructed by using a relational database system. However, management of information is not limited to this. For example, it is feasible that metadata of document is described in the extensible markup language (XML), and stored into a XML database.

In addition, although the editing application program 103 and the printer driver 104 are provided as separated programs in the first embodiment, an integrated application program of these can perform the above processing.

In the first embodiment, the data type of an area is determined from objects, thereby achieving more precise determination on data type than determination based on an image of the area.

Moreover, an image of the area is created from objects by using the first method and the second method, as a result, an integrated image is created per area regardless whether there is a space between objects. This enables the PC 100 to acquire document information composed of each integrated image data of appropriately divided and grouped areas. In other words, because created integrated image data is managed in association with information relevant to document data (such as area coordinates), the document data can be easily reproduced by combining integrated image data.

Furthermore, creation of the integrated image data described above is very useful when acquiring an integrated image of a diagram or a graph that includes a lot of blank spaces between circles and/or lines.

In addition, an integrated image associated with positional coordinates is registered into the area management table, so that when the user refers the integrated image, the user can identify at which position in which document data an area of the integrated image is present. This improves convenience.

Moreover, feature amounts are registered in association with respective integrated images. This enables the user to search the integrated images based on the feature amounts, thereby easily detecting a desired integrated image.

Furthermore, because the above processing is performed when the user inputs a print request via the editing application program, while the user does not realize and does not need to perform special processing, an integrated image is created and registered into the database. This reduces operational efforts by the user, thereby achieving an easy registration.

The present invention is not limited to the above embodiments. Various modifications are available as described below.

In the first embodiment, a stand alone system operated by the PC 100 is explained. However, a first modification of the present invention can be applied to a server-client system.

For example, the system can have configuration that a PC and a control server are connected each other via a network. The PC can register document data into the control server from a printer driver via the network.

To search or refer document data by the PC, for example, the PC can pre-install thereon a Web browser, and another server, such as a Web application server, can perform processing in response to a request from the Web browser.

Furthermore, registration of document data is not limited to an approach that a PC uses a printer driver. The PC can also use a Web browser or an application program for registration to register document data.

Moreover, image forming devices, such as multi function peripherals, other than a PC can register input document data in accordance with the above processing procedure.

In the first embodiment, an integrated image is also created in a text area that includes only a character object. However, according to a second modification of the present invention, the text area can be stored into the area management table as text information instead of creating the integrated image, because the character object holds information, such as font data.

In this case, the area management table needs fields for items, such as font size, font name, and line direction. When displaying an area, a page, or the like, a screen is displayed in accordance with these information, thereby reproducing the layout of an original page. This can reduce data volume to be stored in the storage unit, because the storage unit does not hold integrated image data of text area.

The information processing apparatus according to the embodiments of the present invention can create an appropriate integrated image per area, thereby acquiring document information including integrated images that present appropriate areas.

Moreover, the information processing apparatus can precisely identify a data type of an area, thereby narrowing down integrated images with the data type when a user searches the integrated images.

Furthermore, the information processing apparatus can search integrated images based on feature information, thereby improving convenience.

Moreover, the information processing apparatus can acquire an integrated image that presents a highly precise diagram or a graph.

Furthermore, the information processing apparatus acquires an integrated image in response to a print request, therefore a user does not need to pay attention on any special processing to acquire the integrated image.

In addition, according to the embodiments of the present invention, an information processing program that causes a computer to execute an information processing method according to the embodiments can be provided.

Moreover, a computer-readable recording medium that stores thereon the information processing program can be provided.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an input unit to receive input of object information and positional information for each object, the object information being information about each of the objects rendered in a certain unit that is included in a page of document information, and the positional information being information about object position of each of the objects within the document information;
an extracting unit to extract objects included in an area in the document information based on the positional information; and
an integrating unit to integrate extracted objects to create an integrated image of the area.

2. The information processing apparatus according to claim 1, further comprising a determining unit to determine, based on the positional information of each the objects, whether two or more objects superimpose on each other, wherein
the extracting unit extracts objects that the determining unit determines to superimpose on each other.

3. The information processing apparatus according to claim 1, further comprising:
an extending unit to extend an area of each of the objects to a certain scale on the page in the document information obtained based on the positional information of each of the objects; and
a determining unit to determine, based on the positional information of each the objects, whether two or more objects in extended area superimpose on each other, wherein
the extracting unit extracts objects that the determining unit determines to superimpose on each other.

4. The information processing apparatus according to claim 1, further comprising a determining unit to determine a type of the area based on extracted objects.

5. The information processing apparatus according to claim 4, further comprising a feature creating unit to create feature information indicating a feature of the area based on the extracted objects, wherein
the determining unit determines the type based on created feature information.

6. The information processing apparatus according to claim 1, further comprising:
a storage unit to store therein information;
an image-position extracting unit to acquire positional information of the integrated image based on arrangement of the objects on the page; and
a registering unit to associate and register the integrated image and acquired positional information of the integrated image into the storage unit.

7. The information processing apparatus according to claim 1, further comprising:
a storage unit to store therein information;
a feature creating unit to create feature information indicating a feature in the area based on the extracted objects;
a registering unit to associate the integrated image with created feature information, and registers the integrated image associated with the feature information as area information into the storage unit.

8. The information processing apparatus according to claim 7, further comprising a searching unit to acquire the integrated image by searching the area information with a feature amount as a key.

9. The information processing apparatus according to claim 1, wherein the input unit receives input of object information that is information about objects that form a schematic included in the page.

10. The information processing apparatus according to claim 1, further comprising a print output unit to divide the document information into each object, and output object information of each of the objects and positional information of each of the objects within the document information, wherein
the input unit receives an input of the object information of each of the objects, and an input of the positional information of each of the objects, both of which are output by the print output unit.

11. A method of processing information, comprising:
receiving input of object information and positional information for each object, the object information being information about each of the objects rendered in a certain unit that is included in a page of document information, and the positional information being information about position of each of the objects within the document information;
extracting objects included in an area in the document information based on the positional information; and
integrating extracted objects thereby creating an integrated image of the area.

12. The method according to claim 11, further comprising determining, based on the positional information of each the objects, whether two or more objects superimpose on each other, wherein
the extracting includes extracting objects that are determined to superimpose on each other at the determining.

13. The method according to claim 11, further comprising:
extending an area of each of the objects to a certain scale on the page in the document information obtained based on the positional information of each of the objects; and
determining, based on the positional information of each the objects, whether two or more objects in extended area superimpose on each other, wherein
the extracting includes extracting objects that are determined to superimpose on each other at the determining.

14. The method according to claim 11, further comprising determining a type of the area based on extracted objects.

15. The method according to claim 14, further comprising creating feature information indicating a feature of the area based on the extracted objects, wherein
the type is determined at the determining based on created feature information.

16. The method according to claim 11, further comprising:
extracting positional information of the integrated image based on arrangement of the objects on the page; and
associating and registering the integrated image and acquired positional information of the integrated image into a storage unit.

17. The method according to claim 11, further comprising:
creating feature information indicating a feature in the area based on the extracted objects;
associating the integrated image with created feature information, and registering the integrated image associated with the feature information as area information into a storage unit.

18. The method according to claim 17, further comprising acquiring the integrated image by searching the area information with a feature amount as a key.

19. The method according to claim 11, wherein the receiving includes receiving input of object information that is information about objects that form a schematic included in the page.

20. A computer program product comprising a computer usable medium having computer readable program codes embodied in the medium that when executed causes a computer to perform a method comprising:
receiving input of object information and positional information for each object, the object information being information about each of the objects rendered in a certain unit that is included in a page of document information, and the positional information being information about position of each of the objects within the document information;
extracting objects included in an area in the document information based on the positional information; and
integrating extracted objects thereby creating an integrated image of the area.
